(19) United States
(12) Patent Application Publication
(10) Pub. No.: US 2006/0030380 A1
(43) Pub. Date: Feb. 9, 2006

(54) Mobile communication and gaming terminal

(76) Inventor: Pasi Pentinpuro, Ahmas (FI)

Correspondence Address: PERMAN & GREEN, 425 POST ROAD, FAIRFIELD, CT, 06824, US

(21) Appl. No.: 10/910,503

(22) Filed: Aug. 3, 2004

(51) Int. Cl. H04M 1/00

(52) U.S. Cl. 455/575.3; 455/556.1

(57) ABSTRACT

A mobile communication terminal comprising at least one housing part that can swing relative to another housing part between a retracted and an open position and vice versa. A first keypad is always accessible, whilst a second keypad is accessible only in the extended position. The layout of the phone in the extended position renders the terminal particularly useful for gaming applications. The terminals are thus suited for both mobile communication and mobile gaming purposes.

The present invention relates to mobile communication terminals comprising at least one housing part that can swing relative to another housing part and in particular such terminals that are suited for both communication and gaming purposes.

### BACKGROUND ART

Mobile communication terminals, e.g. mobile phones, personal digital assistants (PDA) or the like nowadays are provided with a variety of different functions which go far beyond that of placing and receiving simple mobile phone calls. Manufacturers of mobile telecommunication terminals are driven to come up with all-in-one mobile devices, so that organizers, office applications, internet browsers and game platforms are no longer novelties on these devices. Even though the traditional mobile telecommunication terminal has thereby developed into a multifunctional device, it is still generally referred to as a mobile phone in everyday usage. For simplicity, a mobile communication terminal will therefore also be referred to as a mobile phone hereafter; also it defines a device which provides further functionalities such as those indicated above.

As mobile phones are increasingly used as mobile gaming terminals, a multitude of games are directly available—or available for download—on most mobile phones. A user can play a game by him/herself with the mobile phone usually in stand-by-mode or he can play together with several other players to whom he/she is linked over a cellular telecommunication network or via a short range wireless communication technology such as Bluetooth.

The layout of a conventional “upright” mobile communication terminal—a mobile phone—with e.g. a 3 by 4 alphanumerical keypad (ITU-T keypad), a few softkeys and a four-way navigation pad below the display is however not ideal for playing games. These conventional mobile phones are also during gaming typically held upright in one hand and operated with the thumb of the same hand. Even with a very good reactivity and finger agility, a user has to develop an enormous skill when the small and narrowly spaced keys on his mobile phone are his only gaming control means. For not exceptionally skilled persons or persons with thicker fingertips, the keypad layouts of their mobile phones form the main hurdle in their pursuit of a high score.

Dedicated mobile gaming terminals, such as the Gameboy Advance®, are typically held sandwiched horizontally between two hands, and the layout of the controls allows the thumb of one hand to operate a directional input device such as a navigation pad or a joystick and the thumb of other hand to operate two input or firing buttons. The directional input device is used when a game character being shown on the display is to be moved or otherwise directionally controlled. The directional input device is provided on the left side of the housing beside the display. The two input or fire buttons are provided on the right side of the housing beside the display. The input or fire buttons are operated when it is necessary to control the game character being shown on the display to perform various predetermined actions. For example, when one of the input or fire buttons is depressed, the game character may appear to jump, or when the other input or fire button is depressed, the character may appear to throw a stone, or a ball, or launch various other objects. Thus, the navigation pad is disposed to be operated by the thumb of the left hand, which sandwiches the housing in cooperation with the right hand, and the input or fire buttons are disposed to be operated by the thumb of the right hand.

The Nokia N-gage® is a mobile terminal suited for both gaming and communication. The layout is similar to that of a dedicated gaming terminal, i.e. the terminal is in use held horizontally with both hands. A directional input device in the form of a 5-way navigation pad is arranged on the left side of the display. A 3 by 4 ITU-T keypad is arranged on the right side of the display. The “5jkl” and “7pqrs” keys of the ITU-T keypad are used as action or firing buttons during gameplay. The layout of the Nokia N-Gage® results however in a relatively large device. The ITU-T keypad needs to have a minimum size for acceptable operability and thus the housing part on the right side of the display must be accordingly sized to accommodate the ITU-T keypad. For esthetic and technical reasons it is desirable that the left and right housing parts are identically sized to obtain a symmetrical device, and thus both housing parts need to be relatively large. Using the keys of the ITU-T keypad as action or firing buttons is not ideal, since the closely spaced keys could easily lead to inadvertedly depressing an adjacent (functionless) key.

Another solution to provide gaming functionality on a mobile phone is disclosed in WO 2004/007041. This game controller device is clicked on the back of an upright mobile telephone, resulting in two panels protruding from the sides of the upright mobile phone. The left panel is provided with a directional input device and the right panel is provided with four action or firing buttons. The game controller is clamped to the mobile phone and the signals generated by actuation of the directional input device and action or firing buttons are sent by a wireless (Bluetooth®) transmitter to a corresponding receiver in the mobile phone. A disadvantage associated with the game controller is the need to be carried along separately and the increase in overall weight and volume of the articles to be transported—which deviates from the desired goal of a compact and truly mobile communication terminal. Further, the Bluetooth transceiver in the mobile phone can currently only communicate with one Bluetooth device at a time, i.e. when the game controller is in use, multiplayer games using Bluetooth wireless technology are no longer possible, neither is the use of a Bluetooth headset.

### DISCLOSURE OF THE INVENTION

The invention described below provides a mobile communication terminal comprising a stationary housing part, a display, a movable housing part that can swing in a plane that is substantially parallel to the plane of the display between a retracted position and an extended position, a first keypad that is accessible in both the retracted and extend position, and a second keypad that is accessible in the extended position and not in he retracted position.

The invention described below further provides a mobile communication terminal comprising an elongated stationary housing part, a display, a movable housing part that can swing in a plane that is substantially parallel to the plane of the display between a retracted position and an extended position, a keypad being disposed beneath the display in the retracted position, and a keypad on the left side of the display and on the right side of the display a keypad being accessible in the extended position.

### BRIEF DESCRIPTION OF THE DRAWINGS

In the following detailed portion of the present description, the invention will be explained in more detail with reference to the exemplary embodiments shown in the drawings, in which:

FIG. 1 is a front view of a mobile terminal according to a first embodiment with its movable part in the retracted position;

FIG. 2 is a side view of the terminal of FIG. 1;

FIG. 3 is a front view of the terminal of FIG. 1 with the movable part in the extended position;

FIG. 4 is a is a front view of a mobile terminal according to a second embodiment with its movable part in the retracted position;

FIG. 5 is a side view of the terminal of FIG. 4;

FIG. 6 is a rear view of the terminal of FIG. 4;

FIG. 7 is a front view of the terminal of FIG. 7 with the movable part in the extended position;

FIG. 8 is a is a front view of a mobile terminal according to a third embodiment with its movable part in the retracted position,

FIG. 9 is a front view of the terminal of FIG. 8 with the movable part in the extended position; and

FIG. 10 is a side view of the terminal shown in FIG. 9.

### DETAILED DESCRIPTION

The mobile phones 1 according to the preferred embodiments described herein are adapted for communication via a cellular network, such as the GSM 900/1800 MHz network, but could just as well be adapted for use with a Code Division Multiple Access (CDMA) network, a 3G network, or a TCP/IP-based network (e.g. via WLAN, WIMAX or similar).

The mobile phones according to the preferred embodiments described herein comprise all conventional components (internal components not shown) of a mobile communication terminal such as a microprocessor for controlling the operation of the mobile phone and a program memory for storing programs used by the mobile phone. Input/output circuits interface the microprocessor with the keys, the display, audio processing circuits, receiver, and transmitter.

The audio processing circuits provide basic analog audio outputs to the speaker and accept analog audio inputs from the microphone. A conventional signal combiner permits two-way, fully duplex communication over a common internal antenna. The processor forms the interface to the peripheral units of the apparatus, including a RAM memory and a Flash ROM memory, a SIM card and the keys, multi-way pads and joysticks, as well as data, power supply (rechargeable battery), etc. As these components are well known, they are neither further described in detail nor illustrated in the drawings.

In the preferred embodiments the display 3 is a liquid crystal display (LCD). However, the display can be any type of display and the teaching or the scope of the claims as set forth herein is not limited thereby.

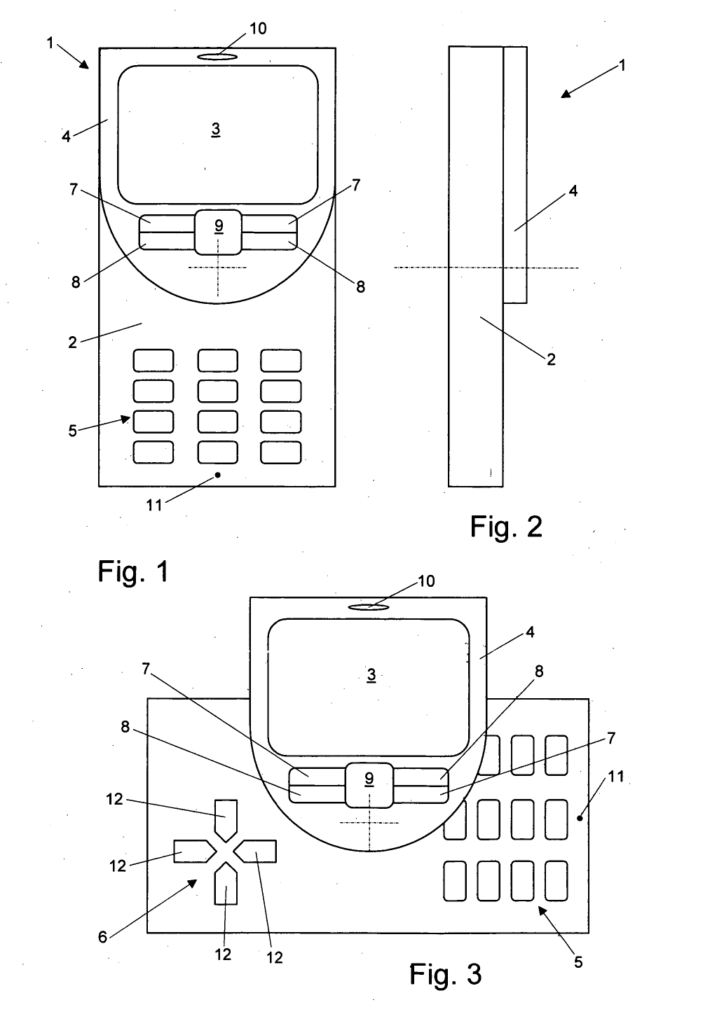

Referring now to FIGS. 1 to 3, a mobile phone 1 according to a first preferred embodiment includes a stationary housing part 2 provided with a 3 by 4 ITU-T keypad 5 with alphanumerical keys and a movable housing part 4 provided with a display 3, two multifunctional softkeys 7, two call handling keys 8 (one on-hook and one off-hook key), a multi-directional navigation pad 9, an earpiece 10 (only the opening thereof is shown) and a microphone 11 (only the opening thereof is shown).

In the retracted position the mobile phone 1 can be used in a conventional upright manner, with the alphanumerical ITU-T keypad 5 below the display. In the retracted position the mobile phone 1 is compact and conveniently fits into e.g. a trouser pocket or carrying case.

The moveable housing part 4 can pivot in a plane that is substantially parallel to the plane of the display 3 between a retracted position shown in FIG. 1 and an extended position shown in FIG. 3, in which a second keypad 6 is accessible. The movable part 4 is pivotably connected to the stationary part—by conventional means such as a shaft received in a bore—about an axis shown by the interrupted lines in the drawings.

When the movable part 4 is moved 90° from the retracted to the extended position the processor recognizes this event by a signal from one or more sensors (not shown) and automatically changes from any communication related mode (e.g. idle mode) to a gaming mode (if the additional keypad 6 is provided with keys that relate to another function than gaming, the processor will change to a mode of operation related to the function concerned).

The second keypad 6 is in this embodiment exemplary provided with a directional input device in the form of four navigation push-button switches 12, that may be used when a game character shown on the display 3 is to be moved. By depressing any one of the push button-switches 12, it is possible to move the game character upward or downward or leftward or rightward. Two (or more) keys, e.g. the “4ghi”-key and the “8tuv”-key of the ITU-T keypad 5 are operated when it is necessary to control the game character shown on the display 3 to perform various predetermined actions. For example, when the “4ghi”-key is depressed, the displayed character may appear to jump, or when the “8tuv”-key is, depressed, the character may appear to throw a stone, or a ball, or launch various other objects. If the game character is a vehicle or the like the push-button switches 12 are used to steer the vehicle and the keys of the keypad 5 are used to control throttle, power, brakes, gearshift, etc.

The stationary part 2 is in use held horizontally when the movable part 4 is in the extended position. Thus, the navigation/steering push-button switches 12 of the second keypad 6 are disposed to be operated by the thumb of the left hand, which sandwiches the stationary housing 2 in cooperation with the right hand, and the push-button switches/keys of keypad 5 are disposed to be operated by the thumb of the right hand. The display 3 is disposed centrally. This layout renders the terminal particularly suitable for gaming.

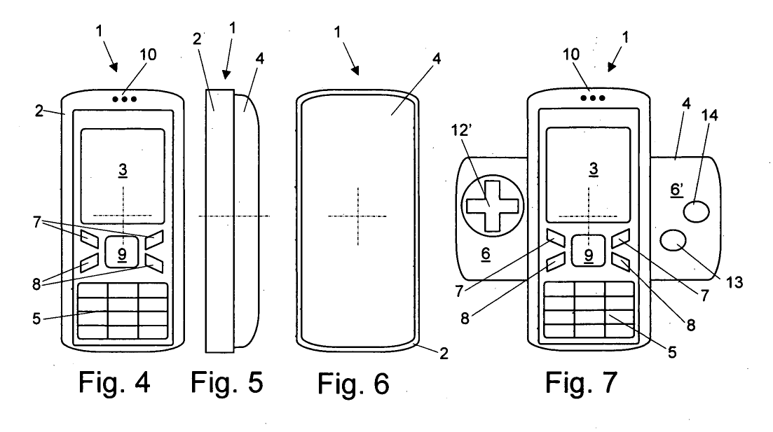

Referring now to FIGS. 4 to 7, a mobile phone 1 according to a second preferred embodiment includes a stationary housing part 2 provided with a 3 by 4 ITU-T keypad 5 with alphanumerical keys, a display 3, two multifunctional softkeys 7, two call handling keys 8 (one on-hook and one off-hook key), a multi-directional navigation pad 9, an earpiece 10 (only the openings thereof are shown) and a microphone 11 (only the opening thereof is shown) and a moveable housing part 4.

In the retracted position the mobile phone 1 can be used in a conventional upright manner, with the alphanumerical ITU-T keypad 5 below the display. In the retracted position the mobile phone 1 is compact and conveniently fits into e.g. a trouser pocket or carrying case.

The moveable housing part 4 can pivot in a plane that is substantially parallel to the plane of the display 3 between a retracted position, shown in FIGS. 4, 5 and 6, and an extended position shown in FIG. 7, in which a second keypad 6 and a third keypad 6′—disposed on the movable housing part 4—are accessible (i.e. can be operated by a user with his/her fingers). The movable part 4 is pivotably connected to the stationary part—by conventional means such as a shaft received in a bore—about an axis shown by the interrupted lines in the drawings.

When the movable part 4 is moved 90° from the retracted to the extended position the processor recognizes this event by a signal from one or more sensors (not shown) and automatically changes from any communication related mode (e.g. idle mode) to a gaming mode (if the second keypad 6 is provided with keys that relate to another function than gaming, the processor will change to a mode of operation related to the function concerned).

In this embodiment the second keypad 6 is exemplary provided with a directional input device in the form of a four way navigation pad 12′, that can be used e.g. when a game character shown on the display 3 is to be moved. By depressing any one of the four ways of the navigation pad 12′, it is possible to move the game character upward or downward or leftward or rightward.

The third keypad 6′ is provided with two (possibly more) push-button switches 13 and 14 (firing or action buttons) which are operated when it is necessary to control the game character shown on the display 3 to perform various predetermined actions. For example, when push-button switch 13 is depressed, the displayed character may appear to jump, or when push-button switch 14 is depressed, the character may appear to fire a weapon, or launch various other objects. If the game character is a vehicle or the like the navigational pad 12′ is used to steer the vehicle and the push-button switches of the third keypad 6′ are used to control throttle, power, brakes, gearshift, etc.

In use the stationary part 2 is upright when the movable part 4 is in the extended, i.e. horizontal position. Thus, the navigation, pad 12′ of the second keypad 6 is disposed on the left side of the display to be operated by the thumb of the left hand, which sandwiches the stationary housing 2 in cooperation with the right hand, and the push-button switches 13 and 14 of keypad 6′ are disposed on the right side of the display 3 to be operated by the thumb of the right hand. The display is disposed centrally. This layout renders the terminal particularly suitable for gaming.

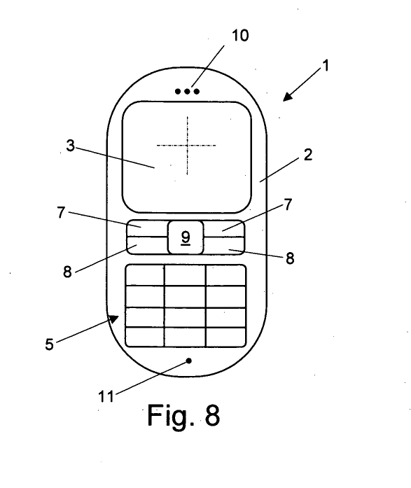

Referring now to FIGS. 8 to 11, a mobile phone 1 according to a third preferred embodiment includes a stationary housing part 2 provided with a 3 by 4 ITU-T keypad 5 with alphanumerical keys, a display 3, two multifunctional softkeys 7, two call handling keys 8 (one on-hook and one off-hook key), a multi-directional navigation pad 9, an earpiece 10 (only the openings thereof are shown) and a microphone 11 (only the opening thereof is shown) and a movable housing part 4.

In the retracted position the mobile phone 1 can be used in a conventional upright manner, with the alphanumerical ITU-T keypad 5 below the display. Furthermore, in the retracted position the mobile phone 1 is compact and conveniently fits into e.g. a trouser pocket or carrying case.

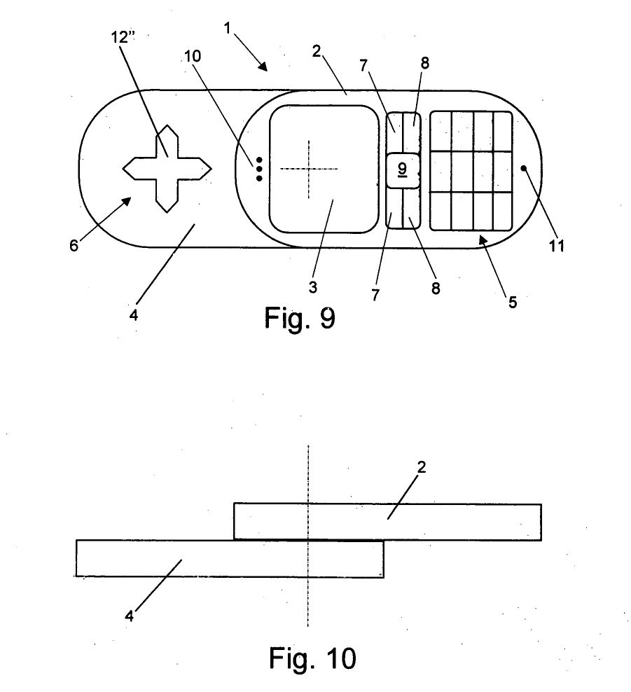

The moveable housing part 4 can pivot in a plane that is substantially parallel to the plane of the display 3 between a retracted position shown in FIG. 8 and an extended position shown in FIGS. 9 and 10 in which a second keypad 6 is accessible. The movable part 4 is pivotably connected to the stationary part—by conventional means such as a shaft received in a bore—about an axis shown by the interrupted lines in FIGS. 8 to 10.

When the movable part 4 is moved 180° clockwise or counterclockwise from the retracted to the extended position the processor recognizes this event by a signal from one or more sensors (not shown) and automatically changes from any communication related mode (e.g. idle mode) to a gaming mode (if the second keypad 6 is provided with keys that relate to another function than gaming, the processor will change to a mode of operation related to the function concerned). The processor will simultaneously change the orientation of the information shown on the display 3 by 90° to mach the new orientation of the stationary housing part 2, and vice versa.

The second keypad 6 is in this embodiment exemplary provided with a directional input device in the form of a four-way navigation cross 12″, that can be used e.g. when a game character being displayed on the display 3 is to be moved. By depressing any one of the arms of the cross 12″, it is possible to move the game character upward or downward or leftward or rightward. Two (or more) keys, e.g. the “4ghi”-key and “8tuv”-key, of the ITU-T keypad 5 are operated when it is necessary to control the game character shown at a particular time on the display 3 to perform various predetermined actions. For example, when the “4ghi”-key is depressed, the displayed character may appear to jump, or when the “8tuv”-key is depressed, the character may appear to throw a stone, or a ball, or launch various other objects. If the game character is a vehicle or the like the cross 12″ are used to steer the vehicle and the keys of the keypad 5 are used to control throttle, power, brakes, gearshift, etc.

The stationary part 2 is in use held horizontally when the movable part 4 is in the extended position. Thus, the navigation/steering push-button switches 12 of the second keypad 6 are disposed to be operated by the thumb of the left hand, which sandwiches the stationary housing 2 in cooperation with the right hand, and the push-button switches/keys of keypad 5 are disposed to be operated by the thumb of the right hand. The display is disposed centrally. This layout renders the terminal particularly suitable for gaming.

Although the present invention has been described in detail for purpose of illustration, it is understood that such detail is solely for that purpose, and variations can be made therein by those skilled in the art without departing from the scope of the invention.

1. A mobile communication terminal comprising:
a stationary housing part;
a display;
a movable housing part that can swing in a plane that is substantially parallel to the plane of the display between a retracted position and an extended position;
a first keypad that is accessible in both the retracted and extend position; and
a second keypad that is accessible in the extended position and not in the retracted position.

2. A mobile communication terminal according to claim 1, wherein the display is disposed on the moveable housing part.

3. A mobile communication terminal according to claim 1, wherein the second keypad is disposed on the moveable housing part.

4. A mobile communication terminal according to claim 1, wherein the second keypad is disposed on the stationary housing part.

5. A mobile communication terminal according to claim 1, wherein the first keypad comprises a standard ITU-T keypad.

6. A mobile communication terminal according to claim 1, wherein the second keypad is a game keypad.

7. A mobile communication terminal according to claim 1, wherein the movable housing part swings about a pivot axis that is positioned at a substantially central position of the stationary housing part.

8. A mobile communication terminal according to claim 1, wherein the movable housing part swings about a pivot axis that is positioned at a substantially central position of the movable housing part.

9. A mobile communication terminal according to claim 1, wherein the movable housing part swings about a pivot axis that is positioned near an extremity of the movable housing part.

10. A mobile communication terminal according to claim 1, wherein the angle between the extended and retracted position is substantially 90°.

11. A mobile communication terminal according to claim 1, wherein the angle between the extended and retracted position is substantially 180°.

12. A mobile communication terminal according to claim 1, wherein the terminal is configured to automatically change, if required, the mode of operation from a communication mode to a gaming mode when the movable housing part is moved from the retracted position to the extended position and vice versa.

13. A mobile communication terminal according to claim 1, wherein the terminal is configured to automatically change, if required, the orientation of information shown on the display when the movable housing part is moved from the retracted position to the extended position and vice versa.

14. A mobile communication terminal according to claim 1, wherein a second and a third keypad are accessible in the extended position and not in the retracted position.

15. A mobile communication terminal according to claim 14, wherein said second and third keypad are both disposed on the movable housing part, and said second and third keypad in the extended position preferably are disposed on opposite sides of the stationary housing part.

16. A mobile communication terminal according to claim 13, wherein said second and/or third keypad comprises a directional gaming input device, preferably a navigation pad or a joystick, and/or action or firing gaming input devices, preferably push-button switches.

17. A mobile communication terminal comprising:
an elongated stationary housing part;
a display;
a movable housing part that can swing in a plane that is substantially parallel to the plane of the display between a retracted position and an extended position;
a keypad disposed beneath the display in the retracted position; and
a keypad on the left side of the display and a keypad on the right side of the display being accessible in the extended position.

18. A mobile communication terminal according to claim 17, wherein the display is disposed on the moveable housing part and the keypad that is arranged beneath the display in the retracted position is disposed beside the display in the extended position.

19. A mobile communication terminal according to claim 17, wherein the display is disposed on the stationary housing part and the keypad that is arranged beneath the display remains in the extended position beneath the display in the retracted position.

20. A mobile communication terminal according to claim 19, wherein the second keypad is disposed on the moveable housing part.

21. A mobile communication terminal according to claim 18, wherein the second keypad is disposed on the stationary housing part.

22. A mobile communication terminal according to claim 17, wherein the first keypad comprises a standard ITU-T keypad.

23. A mobile communication terminal according to claim 17, wherein the second keypad is a game keypad.

24. A mobile communication terminal according to claim 17, wherein the movable housing part swings about a pivot axis that is positioned at a substantially central position of the stationary housing part.

25. A mobile communication terminal according to claim 17, wherein the movable housing part swings about a pivot axis that is positioned near an extremity of the stationary housing part.

26. A mobile communication terminal according to claim 24, wherein the movable housing part swings about a pivot axis that is positioned at a substantially central position of the movable housing part.

27. A mobile communication terminal according to claim 25, wherein the movable housing part swings about a pivot axis that is positioned near an extremity of the movable housing part.

28. A mobile communication terminal according to claim 17, wherein the rotational angle between the extended and retracted position is substantially 90°.

29. A mobile communication terminal according to claim 28, wherein the rotational angle between the extended and retracted position is substantially 180°.

30. A mobile communication terminal according to claim 17, wherein the terminal is configured to automatically change, if required, the mode of operation from a communication mode to a gaming mode when the movable housing part is moved from the retracted position to the extended position and vice versa.

31. A mobile communication terminal according to claim 17, wherein the terminal is configured to automatically change, if required, the orientation of information shown on the display when the movable housing part is moved from the retracted position to the extended position and vice versa.

32. A mobile communication terminal according to claim 17, wherein two keypads are accessible in the extended position and not in the retracted position.

33. A mobile communication terminal according to claim 32, wherein said two keypads are both disposed on the movable housing part, and said two keypads in the extended position preferably being disposed on opposite sides of the display.

34. A mobile communication terminal according to claim 32, wherein said second/and or third keypad comprises a directional gaming input device and/or an action or firing gaming input device.
